(19) United States
(12) Patent Application Publication
(10) Pub. No.: US 2014/0352472 A1
(43) Pub. Date: Dec. 4, 2014

(54) END CAP-TYPE BALL SCREW ASSEMBLY AND CIRCULATOR

(71) Applicant: UNIVERSAL TRANSMISSION MOTION CORP., Taichung City (TW)

(72) Inventor: WEN-YU HSIEH, TAICHUNG CITY (TW)

(21) Appl. No.: 13/903,139

(22) Filed: May 28, 2013

(51) Int. Cl. F16H 25/22

(52) U.S. Cl. CPC F16H 25/2214
USPC 74/424.87

(57) ABSTRACT

A circulator comprises a circulating body and an extending rib. The circulating body is formed with an arc-shaped circulating passage. The extending rib is integrally radial inwardly extended from a curved portion of the circulating body. The curved portion of the circulating body is configured toward an inner direction of the circulating passage by reinforcement of the extending rib to increase a radius of the circulating passage. Moreover, the instant disclosure further provides an end cap-type ball screw assembly.

### BACKGROUND OF THE INVENTION

1. Field of the Invention

The instant disclosure relates to a ball screw assembly; in particular, to an end cap-type ball screw assembly and a circulator.

2. Description of Related Art

The general motors are operating in rotating movement, but if needing to do linear positioning movement, the motors need to rely on the ball screw assembly. Guiding the rotating movement of the motors into the linear positioning movement, it was also to do with the tooth row, chain, or belt, but after all, its accuracy or stroke accuracy is not as good as the ball screw assembly.

In the manufacturing process of the screw ball assembly, the balls are arranged in the space jointly defined by the screw shaft and the nut, causing a rolling friction between the balls and the screw shaft or the nut when the nut moves with respect to the screw shaft, so that the force provided from the ball screw assembly for moving the motor is effective. Moreover, the types of the screw ball assembly include internal circulation, external circulation, and end cap.

However, the end cap-type ball screw assembly has a plurality of circulators, and the radius of each circulator is limited to the thickness of each circulator, so that the radius of each circulator is limited under a specific value and cannot be increased. Thus, the smooth rolling between the balls and each circulator cannot be improved by increasing the radius of each circulator.

To achieve the abovementioned improvement, the inventors strive via industrial experience and academic research to present the instant disclosure, which can provide additional improvement as mentioned above.

### SUMMARY OF THE INVENTION

One embodiment of the instant disclosure provides an end cap-type ball screw assembly and a circulator each capable of effectively increasing the radius of each circulator.

The end cap-type ball screw assembly, comprises a screw shaft having a spiral rolling groove formed on an outer surface thereof; a nut having a spiral load rolling groove formed on an inner surface thereof, the screw shaft coupled through the nut, the rolling groove aligned with the load rolling groove, and the rolling groove and the load rolling groove jointly defining a raceway; a plurality of balls disposed between the rolling groove of the screw shaft and the load rolling groove of the nut; and two circulators respectively arranged on two opposite sides of the nut, each circulator having an arc-shaped circulating passage, one end of each circulating passage tangent to and in air communication with the raceway, and the balls circulating in the raceway by the circulating passages; wherein each circulator comprises: a circulating body defining the circulating passage and including a curved portion having a radius; and an extending rib integrally and radially formed to inwardly extend from the curved portion of the circulating body; wherein the extending rib is formed to increase the radius of the circulating body.

Preferably, the nut has two separating segments, each of the separating segments is correspondingly configured to the extending rib on a side of each separating segment, and another side of each separating segment is the load rolling groove.

The A circulator, comprises a circulating body formed with an arc-shaped circulating passage, the circulating body has a curved portion having a radius; and an extending rib integrally and radially formed to inwardly extend from the curved portion of the circulating body, wherein the extending rib is configured to increase the radius of the circulating body.

Preferably, the extending rib has a stepped structure having two steps, each step has a treading surface and a riser surface perpendicularly formed with respect to the treading surface, and wherein the smallest thickness of the curved portion of the circulating body is defined by an inner surface of the curved portion and one of the connecting edges between two adjacent steps.

Base on the above, the end cap-type ball screw assembly and the circulator each has the extending rib for increasing the radius of the circulating body. Thus, when the balls roll in the circulating passage of each circulator, the balls roll smoother.

### BRIEF DESCRIPTION OF THE DRAWINGS

FIG. 1 is a perspective view of an end cap-type ball screw assembly according to the instant disclosure;

FIG. 2 is an exploded view of FIG. 1;

FIG. 3 is an exploded view showing another viewing angle of Fig.

FIG. 4 is a partial cross-sectional view along the longitudinal direction of the screw shaft of FIG. 1;

FIG. 5 is a perspective view of a circulator of the end cap-type ball screw assembly according to the instant disclosure;

FIG. 6 is a cross-sectional view of FIG. 5;

FIG. 7 is a comparative view according to the relative art and the instant disclosure;

FIG. 8 is an exploded view of FIG. 5;

FIG. 9 is an exploded view showing another viewing angle of FIG. 8;

FIG. 10 is a perspective view of another type of the circulator of the end cap-type ball screw assembly according to the instant disclosure;

FIG. 11 is a cross-sectional view of FIG. 10; and

FIG. 12 is a perspective view of a first plastic member of the circulator of FIG. 10.

### DETAILED DESCRIPTION OF THE PREFERRED EMBODIMENTS

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

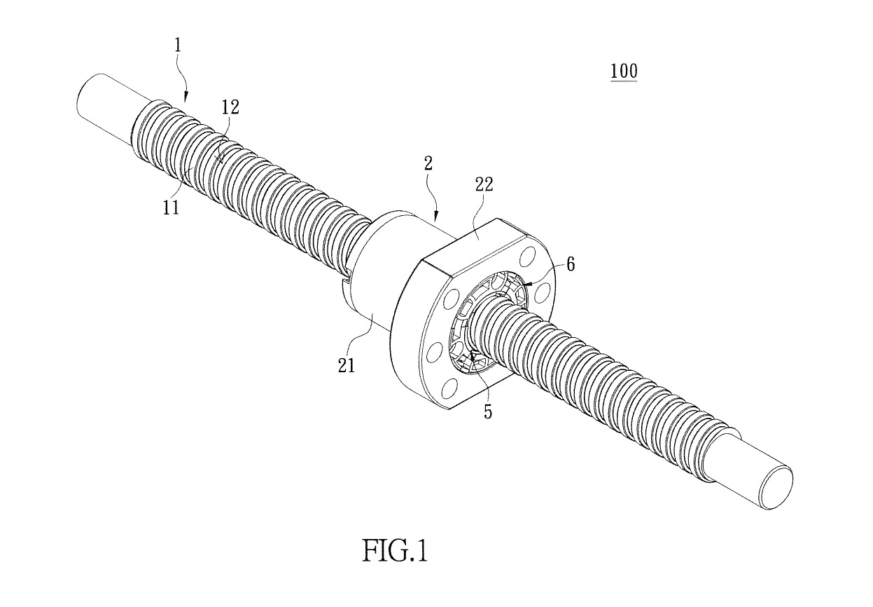

Please refer to FIG. 1, which shows a ball screw assembly of the instant disclosure. The ball screw assembly of this embodiment takes an end cap-type ball screw assembly 100 with single-loop configuration for example, but the end cap-type ball screw assembly 100 is not limited to the single-loop.

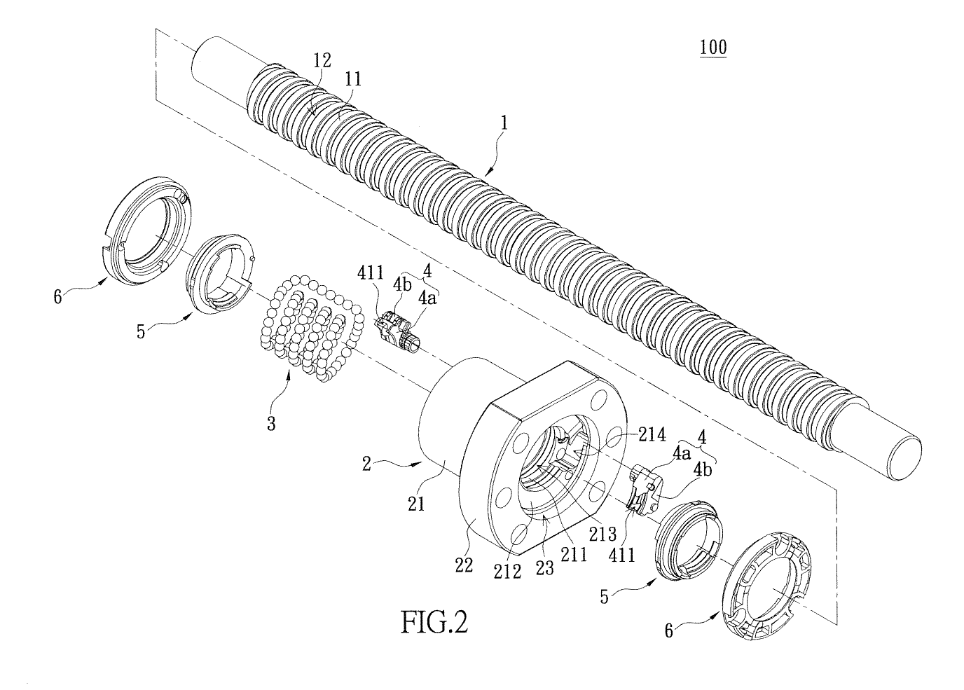

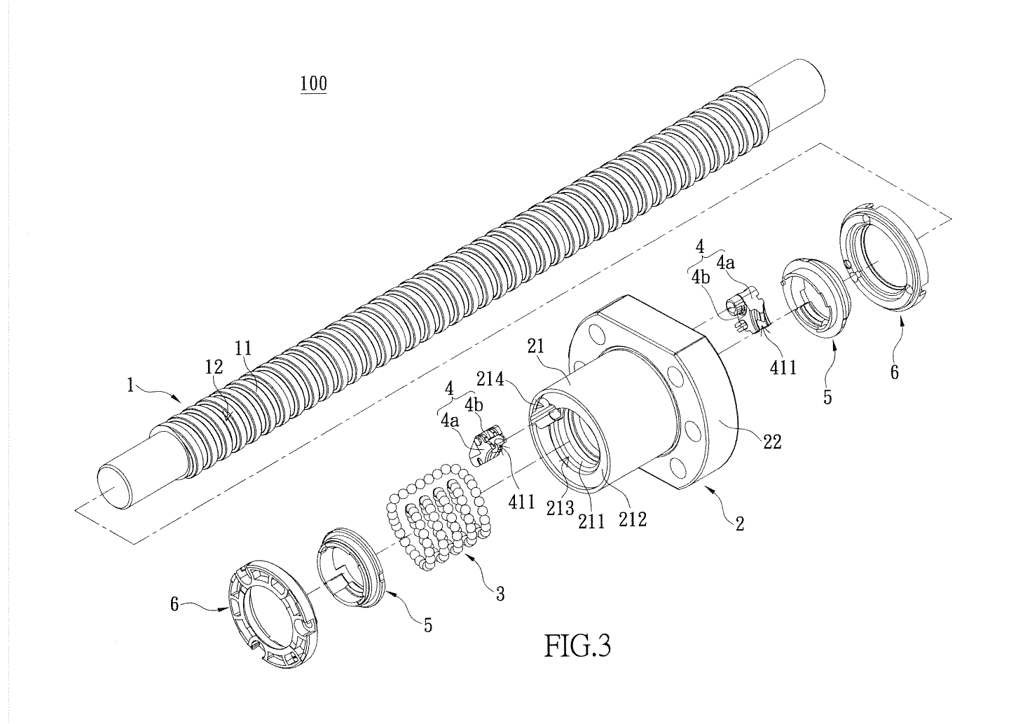

Please refer to FIGS. 2 through 4, the end cap-type ball screw assembly 100 has a screw shaft 1, a nut 2, a plurality of balls 3, two circulators 4, two wipers 5, and two end caps 6. The screw shaft 1 has a substantially cylindrical shape. The screw shaft 1 has a spiral rolling groove 12 formed on an outer surface 11 thereof.

The nut 2 has a tubular main body 21 and a ring shaped receiving body 22 integrally extended from one end of the main body 21. The main body 21 has a spiral load rolling groove 213 formed on an inner surface 211 thereof. The main body 21 has two accommodating slots 214 and a tubular connecting passage 215 in air communication with the accommodating slots 214.

Specifically, the shape of each accommodating slot 214 conforms to the shape of each circulator 4. The accommodating slots 214 are respectively formed on two opposite lateral surfaces 212 of the main body 21, and the connecting passage 215 is formed from the bottom of one accommodating slot 214 linearly extending to the bottom of another accommodating slot 214.

The inner diameter of the receiving body 22 is larger than the inner diameter of the inner surface 211 of the main body 21. The inner surface of the receiving body 22 and the corresponding lateral surface 212 of the main body 21 jointly define a receiving slot 23. An oiling hole (not shown) is concavely formed from the outer surface of the receiving body 22 to the load rolling groove 213.

The screw shaft 1 passes through the nut 2, and the connecting passage 215 is substantially parallel to the longitudinal direction of the screw shaft 1. The rolling groove 12 aligns the load rolling groove 213, and the rolling groove 12 and the load rolling groove 213 jointly form a raceway A. Moreover, some of the balls 3 are sequentially disposed between the rolling groove 12 of the screw shaft 1 and the load rolling groove 213 of the nut 2 for rolling in the raceway A. The lubricating oil can be injected into the raceway A via the oiling hole for reducing the friction generated from the balls 3 in touch with the rolling groove 12 and the load rolling groove 213.

The circulators 4 are respectively disposed on the accommodating slots 214 arranged on the opposite sides of the nut 2. Each circulator 4 defines an arched circulating passage 41. Two opposite ends of each circulating passage 41 are respectively tangent to the raceway A and the connecting passage 215, that is to say, the raceway A, the connecting passage 215, and the circulating passages 41 form a loop. The circulators 4 are arranged with 180 degrees rotation symmetry with respect to a center of the connecting passage 215.

The balls 3 are sequentially recirculated through the raceway A, one of the circulating passages 41, the connecting passage 215, and another circulating passage 41, so that the balls 3 can circulate in the raceway A through the circulating passages 41 and the connecting passage 215.

Specifically, each circulator 4 in this embodiment is formed by a first plastic member 4a and a second plastic member 4b, which having a perpendicular corner portion, for example. But each circulator 4 can be formed integrally, and is not limited to this embodiment.

The circulators 4 are identical structures, so that the following description takes one circulator 4 to explain the detailed features of the circulator 4.

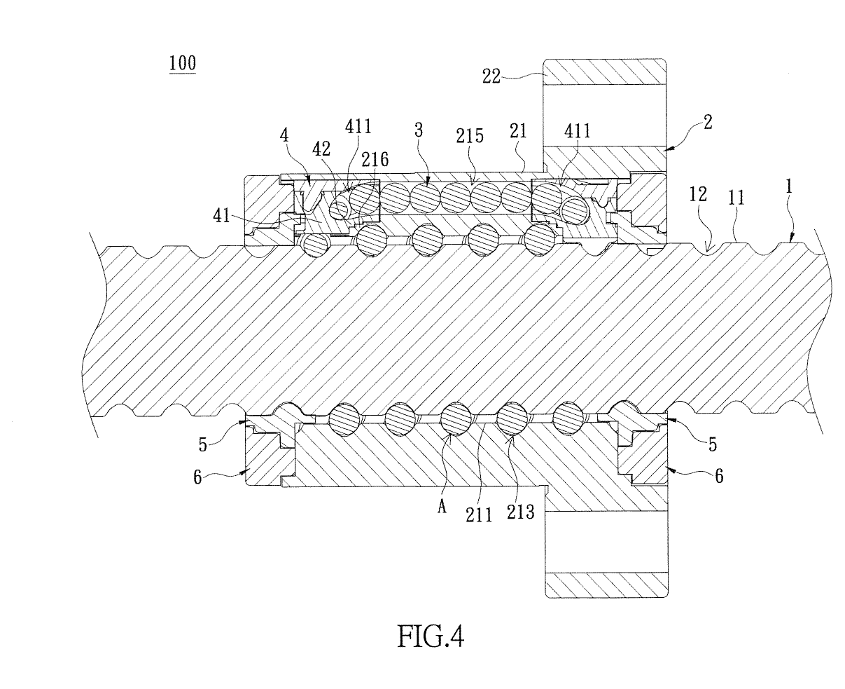

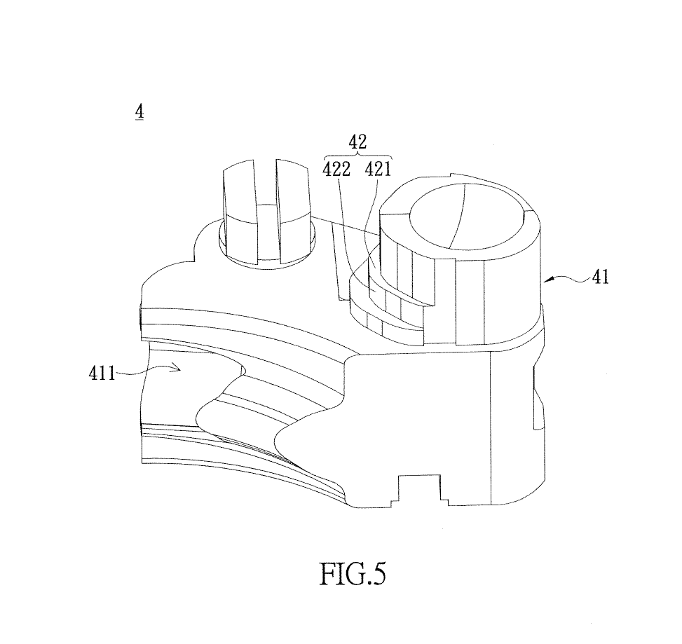

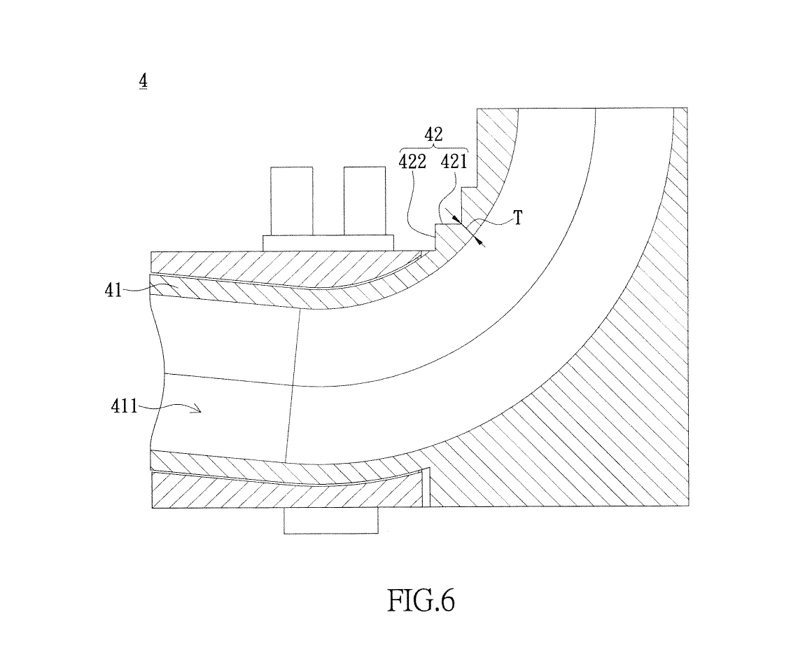

Please refer to FIGS. 4 through 6, which show the cross-sectional contour of each circulator 4, which is L-shaped. Each circulator 4 has a circulating body 41 and an extending rib 42 extended from the circulating body 41. The circulating body 41 is formed with a circular arc-shaped circulating passage 411. As shown in FIG. 6, the circulating body 41 has a curved portion having a radius (not labeled) and a straight portion integrally extended from a lower-left end of the curved portion.

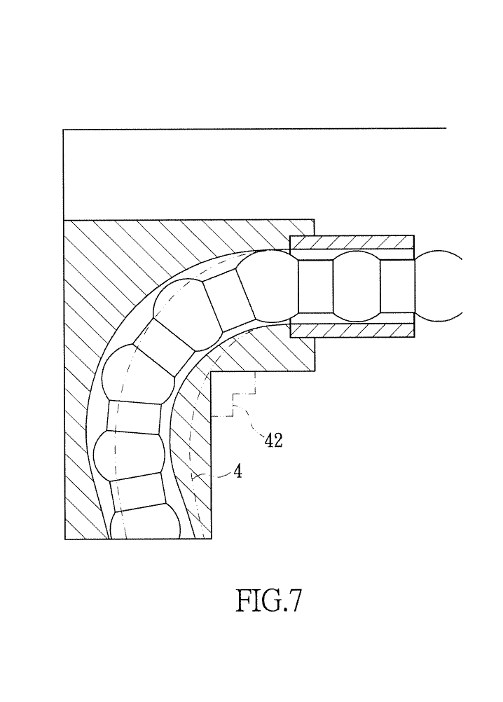

The extending rib 42 is integrally and radially formed to inwardly extend from an outer surface of the curved portion of the circulating body 11. The extending rib 42 is formed to increase the radius and the reinforcement of the curved portion of the circulating body 41 (as FIG. 7 shown).

Specifically, the main body 21 of the nut 2 has two separating segments 216, and the separating segments 216 are respectively corresponding to the extending ribs 42. Each extending rib 42 is located at one side of each separating segment 216, and another side of each separating segment 216 is the load rolling groove 213. In other words, each separating segment 216 conforms to the extending rib 42 of each circulator 4, so that each extending rib 42 are not exposed to the load rolling groove 213.

The minimum thickness of each separating segment 216 is not limited as long as the thickness prevents each extending rib 42 from interfering with the raceway A. That is to say, the extending rib 42 adds thickness to the corresponding curved portion of the circulating body 41. The curved portion of the circulating body 41 is formed toward a radially inward direction of the circulating passage 411 by forming the extending rib 42, thereby increasing the radius of the circulating body 41. Thus, the balls 4 can roll smoothly in the circulating passage 411 of each circulator 4.

The extending rib 42 in this embodiment takes a stepped structure having two steps for example. Specifically, each step of the extending rib 42 has a treading surface 421 and a riser surface 422 perpendicularly connected to the treading surface 421. The smallest thickness T of the curved portion of the circulating body 41 is defined by an inner surface of the curved portion and the connecting edge between two adjacent steps of the extending rib 42

As long as the circulator 4 has enough strength to supply the rolling of the balls 3 via the stepped structure of the extending rib 42, the radius of the circulator 4 can be increased by adjusting the smallest thickness T.

In order to present the main feature of the instant disclosure, this embodiment takes FIG. 7 to show the difference between the related art and the instant disclosure. Specifically, the solid lines of FIG. 7 show the related patent, which has patent number: I 351476, in other words, the solid lines of FIG. 7 show the cross-sectional view of the conventional circulator. The broken lines of FIG. 7 show the circulator 4 of the instant disclosure with respect to the conventional circulator. After comparing the solid lines of FIG. 7 and the broken lines of FIG. 7, the radius of the circulator 4 is increased by forming the extending rib 42.

The extending rib 42 is not limited to the stepped structure of the above description. For example, the extending rib 42 can be formed as an arc-shaped structure.

The above description has already taken one circulator 4 for explaining the detailed features of the circulator 4. The following description states the first plastic member 4a and the second plastic member 4b.

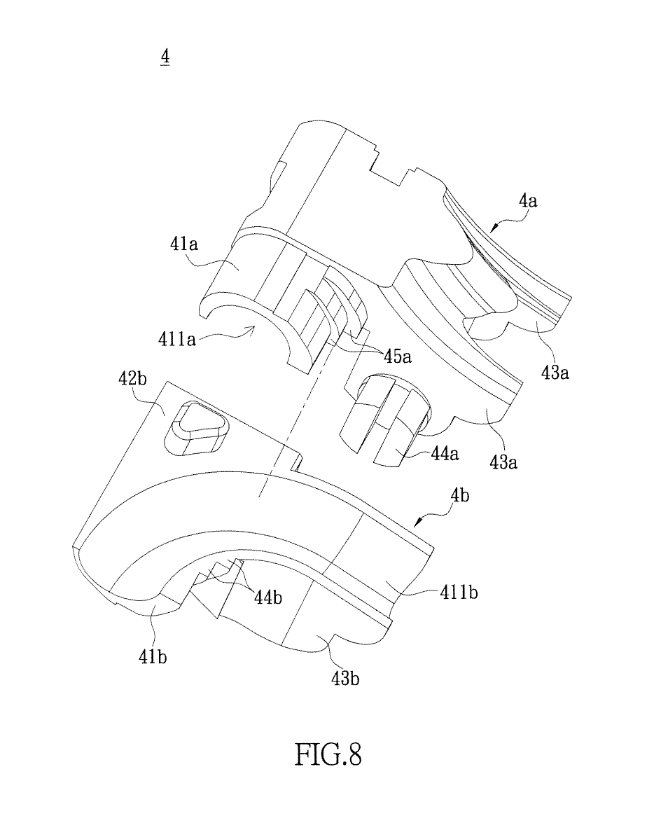

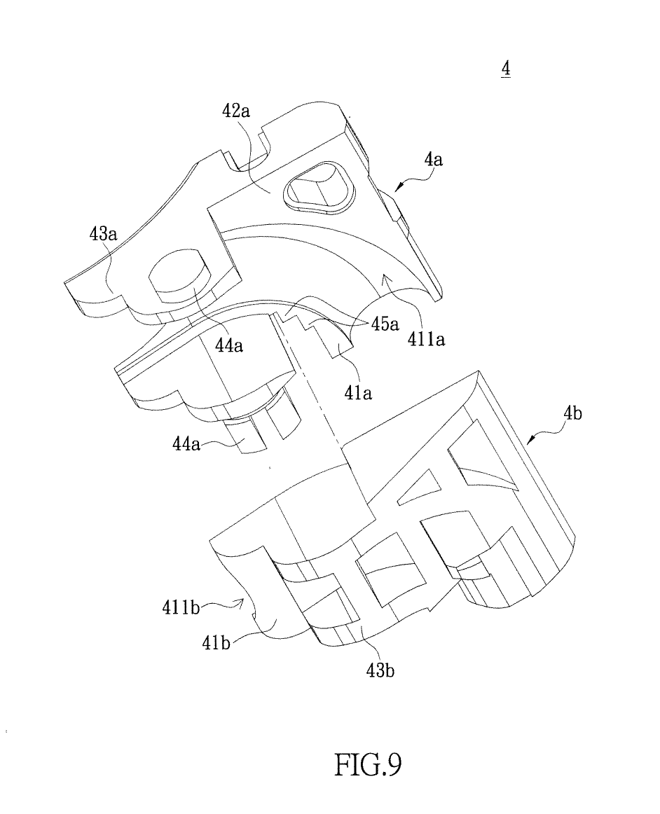

Please refer to FIGS. 8 and 9. The first plastic member 4a has a first circulating body 41a having a half tubular shape, a first coupling block 42a, two positioning sheets 43a, two positioning blocks 44a, and a first extending rib 45a. The first circulating body 41a, the first coupling block 42a, the positioning sheets 43a, and the positioning blocks 44a are the corresponding portions of the circulating body 41. The first extending rib 45a is the corresponding portion of the extending rib 42.

Specifically, the first circulating body 41a has a first circulating groove 411a formed on an inner surface thereof The first coupling block 42a is integrally and radially formed to outwardly extend from an outer surface of a curved portion of the first circulating body 41a. A corner portion of the first coupling block 42a, away from the first circulating groove 411a, is a right angle structure. The positioning sheets 43a are parallel to each other and extended from two opposite sides of a straight portion of the first circulating body 41a corresponding to the straight portion of the circulating body 41, and the positioning blocks 44a are respectively extended from the end portions of the positioning sheets 43a in opposite directions. The first extending rib 45a is integrally radially formed to inwardly extend from the outer surface of the curved portion of the first circulating body 41a.

The second plastic member 4b has a second circulating body 41b having a half tubular shape, a second coupling block 42b, two supporting blocks 43b, and a second extending rib 44b. The second circulating body 41b, the second coupling block 42a, and the supporting blocks 43b are the corresponding portions of the circulating body 41. The second extending rib 44b is the corresponding portion of the extending rib 42.

Specifically, the second circulating body 41b has a second circulating groove 411b formed on an inner surface thereof. The second coupling block 42b is integrally and radially formed to outwardly extend from an outer surface of a curved portion of the second circulating body 41b. A corner portion of the second coupling block 42b, away from the second circulating groove 411b, is a right angle structure. The supporting blocks 43b are extended from the second circulating body 41b, and the position of each supporting block 43b is correspondingly configured to the position of each positioning sheet 43a. The second extending rib 44b is integrally and radially formed to inwardly extend from the outer surface of the curved portion of the second circulating body 41b.

When the first plastic member 4a and the second plastic member 4b are assembled to form the circulator 4, the first circulating groove 411a and the second circulating groove 411b jointly define the circulating passage 411, the first coupling block 42a couples to the second coupling block 42b, and the first extending rib 45a and the second extending rib 44b jointly form the extending rib 42. When the circulator 4 is installed on the accommodating slot 214 of the nut 2, one of the positioning blocks 44a of each circulator 4 is wedged to the nut 2 such that each circulator 4 is further fixed to the nut 2.

Please refer to FIGS. 2 through 4. The wipers 5, each having an annular shape, are respectively screwed on the rolling groove 12 of the screw shaft 1 and arranged on two opposite sides of the main body 21 of the nut 2. The screw shaft 1 passes through the end caps 6, and the end caps 6 are respectively disposed on the opposite sides of the nut 2, in more detail, one of the end caps 6 is received in the receiving slot 23. The other positioning block 44a of each circulator 4 is wedged to each end cap 6 such that each circulator 4 is further fixed to each end cap 6.

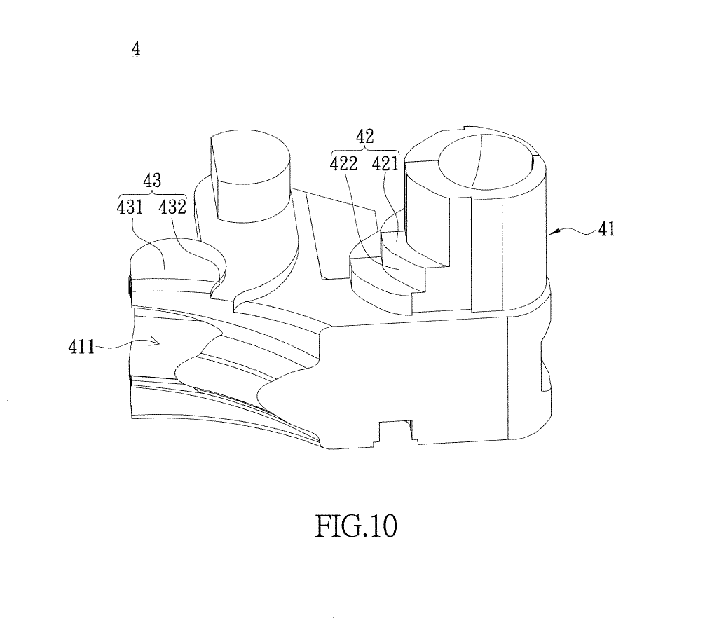

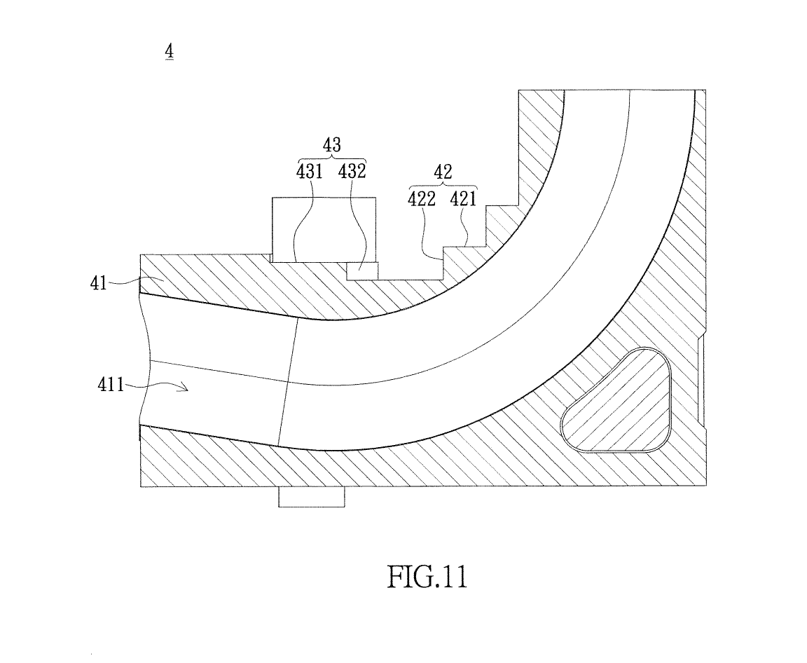

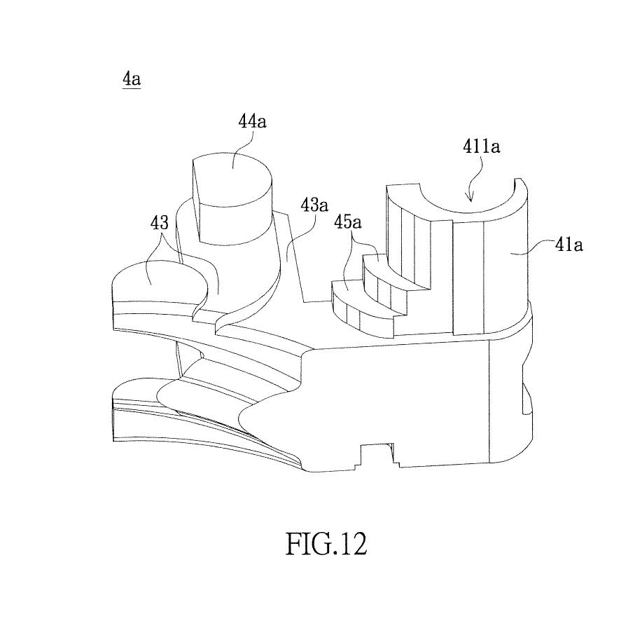

Please refer to FIGS. 10 through 12, which show another embodiment of the instant disclosure. Each circulator 4 of this embodiment further has a reinforcing rib 43 integrally formed on the circulating body 41. Specifically, the reinforcing rib 43 is integrally and radially formed to inwardly extend from an outer surface of one end portion of the circulating body 41 away from the extending rib 42, thereby reinforcing the end portion of the circulating body 41.

The reinforcing rib 43 in this embodiment takes a stepped structure having two steps for example. Specifically, each step of the reinforcing rib 43 has a treading surface 431 and a riser surface 432 perpendicularly connected to the treading surface 431. Thus, the end portion of the circulating body 41, away from the extending rib 42, is reinforced by the stepped structure of the reinforcing rib 43, so that the circulator 4 can provide enough strength for manufacturing by injection molding.

In more detail, the reinforcing rib 43 is extended from an outer surface of the positioning sheet 43a of the first plastic member 4a.

Base on the above, the minimum thickness of each separating segment is not limited as long as the thickness prevents each extending rib from interfering with the raceway. That is to say, the extending rib adds thickness to the corresponding curved portion of the circulating body, so that the curved portion of the circulating body is formed toward the radially inward direction of the circulating passage by forming the extending rib, thereby increasing the radius of the circulating body. Thus, the balls can smoothly roll in the circulating passage of each circulator.

Moreover, after comparing the related art and the instant disclosure as shown in FIG. 7, the instant disclosure presents that the radius of the circulator is increased by forming the extending rib.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An end cap-type ball screw assembly, comprising:
a screw shaft having a spiral rolling groove formed on an outer surface thereof;
a nut having a spiral load rolling groove formed on an inner surface thereof, the screw shaft coupled through the nut, the rolling groove aligned with the load rolling groove, and the rolling groove and the load rolling groove jointly defining a raceway;
a plurality of balls disposed between the rolling groove of the screw shaft and the load rolling groove of the nut; and
two circulators respectively arranged on two opposite sides of the nut, each circulator having an arc-shaped circulating passage, one end of each circulating passage tangent to and in air communication with the raceway, and the balls circulating in the raceway by the circulating passages;
wherein each circulator comprises:
a circulating body defining the circulating passage and including a curved portion having a radius; and
an extending rib integrally and radially formed to inwardly extend from the curved portion of the circulating body;
wherein the extending rib is formed to increase the radius of the circulating body.

2. The end cap-type ball screw assembly as claimed in claim 1, wherein the nut is formed with a connecting passage, the circulators are mated with the nut, and the other end of the circulating passage is tangentially aligned with an end of the connecting passage such that the balls displace from one of the circulators to another one via the connecting passage.

3. The end cap-type ball screw assembly as claimed in claim 2, wherein the nut has two separating segments, each of the separating segments is correspondingly configured to the extending rib on a side of each separating segment, and another side of each separating segment is the load rolling groove.

4. The end cap-type ball screw assembly as claimed in claim 2, wherein the circulators are arranged with 180 degrees rotational symmetry with respect to a center of the connecting passage.

5. The end cap-type ball screw assembly as claimed in claim 1, wherein each circulator is jointly formed by a first plastic member and a second plastic member.

6. The end cap-type ball screw assembly as claimed in claim 1, wherein each extending rib has a stepped structure.

7. The end cap-type ball screw assembly as claimed in claim 6, wherein each stepped structure has at least two steps, and each step has a treading surface and a riser surface perpendicularly formed with respect to the treading surface, and wherein the smallest thickness of the curved portion of the circulating body is defined by an inner surface of the curved portion and one of the connecting edges between two adjacent steps.

8. A circulator, comprising:
a circulating body formed with an arc-shaped circulating passage, the circulating body has a curved portion having a radius; and
an extending rib integrally and radially formed to inwardly extend from the curved portion of the circulating body, wherein the extending rib is configured to increase the radius of the circulating body.

9. The circulator as claimed in claim 8, further comprising:
a reinforcing rib integrally and radially formed to inwardly extend from an end portion of the circulating body.

10. The circulator as claimed in claim 8, wherein the extending rib has a stepped structure having two steps, each step has a treading surface and a riser surface perpendicularly formed with respect to the treading surface, and wherein the smallest thickness of the curved portion of the circulating body is defined by an inner surface of the curved portion and one of the connecting edges between two adjacent steps.
